(19) United States
(12) Patent Application Publication
(10) Pub. No.: US 2009/0162566 A1
(43) Pub. Date: Jun. 25, 2009

(54) METHOD FOR THE SELECTIVE COATING OF A SURFACE WITH LIQUID

(76) Inventors: Erwin Yacoub-George, Munchen (DE); Sabine Scherbaum, Munchen (DE); Christof Landesberger, Grafelfing (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/338,198

(22) Filed: Dec. 18, 2008

(30) Foreign Application Priority Data
Dec. 20, 2007 (DE) 102007061465.0

(51) Int. Cl. B05D 3/10

(52) U.S. Cl. 427/535

(57) ABSTRACT

The present invention relates to a method for the selective coating of a surface of a substrate with liquid, wherein the surface to be selectively coated with liquid comprises regions exhibiting different surface energies, and wherein prior to wetting a fluorine-containing plasma gas is directly acting on the regions exhibiting different surface energies.

The present invention refers to a method for the selective coating of a surface with liquid. In particular the present invention also relates to a selective surface modification of metal-patterned plastic films by means of plasma processes.

The selective application of a liquid to specific regions of a solid-state surface, e.g. the application of adhesive spots, is normally carried out in industrial production by means of automatic metering devices. These automatic metering devices comprise an X,Y-positioning unit in combination with a metering unit, whereby liquid can be metered by means of the metering unit and applied by means of the X,Y-positioning unit in a targeted and fully automatic way into the pre-defined regions.

However, for applications in the case of which tiny amounts of liquid must be metered and/or a very great number of liquid spots must be placed, such robot-based solutions come up against their technical and economic limits.

It is known from U. Srinivasan, D. Liepmann, R. T. Howe, “Microstructure to Substrate Self-Assembly Using Capillary Forces”, Journal of Microelektromechanical Systems, Vol. 10, 2001, p. 17-24 that liquids are applied locally to solid-state surfaces by defining regions with different wetting behaviors, so that the targeted metering of liquids by means of automatic metering devices can be dispensed with.

A precondition is that the difference in the wetting behavior between the different regions on the surface is appropriately great. It must be borne in mind that the wetting behavior on the surface depends on the interfacial energy of the respective liquid and on the surface energy of the solid. The differences in the surface energies between the different surface regions of the solid must thus be matched to the liquid to be metered if the above-described effect is to be achieved.

When solid-state surfaces exhibiting pronounced differences in the wetting behavior are wetted over the whole surface with a liquid (e.g. by spraying, coating with a doctor blade, or immersion), the liquid will preferably deposit on the regions that can be easily wetted by the liquid. By contrast, the liquid rather tends to pearl off from the regions exhibiting poor wettability. It is thereby possible to apply, for instance, adhesives in a targeted way to specific spots of a foil or film surface without the need for using a special automatic metering device (dispenser).

Plasma processes are very well suited for setting the wetting behavior of plastic surfaces.

With an appropriate masking technique, regions showing different wetting behaviors can be formed in a selective way by means of plasma processes on a plastic surface, as is known from A. Ohl, K. Schröder “Plasma-induced chemical micropatterning for cell culturing applications: a brief review”, Surface and Coatings Technology 116-119(1999) 820-830) and from N. A. Bullett, D. P. Bullett, F. E. Truica-Marasescu, S. Lerouge, F. Mwale, M. R. Wertheimer “Polymer surface micropatterning by plasma and VUV-photochemical modification for controlled cell culture”, Applied Surface Science 235 (2004), 395-405.

To this end the plastic surface is first treated over the whole area, for instance, with a hydrophilized plasma. Subsequently a correspondingly patterned mask, e.g. made of an adhesion film, a metal foil or a photolithographic mask, is applied to this hydrophilized plastic surface. If a hydrophobized plasma is now acting on this previously hydrophilized plastic surface, which is partly covered by the patterned mask, only those regions on the plastic surface will be hydrophobized that are not covered by the mask. In a final step the mask must be removed again. Subsequently, the plastic surface treated in this way ideally exhibits sharply defined regions with different wetting behaviors.

This technology, however, has two essential drawbacks that make a commercial application difficult.

For instance, there must be a very intimate contact between patterned mask and substrate surface for efficiently restricting the plasma to the uncovered region and for achieving the desired sharp boundary lines. This state is very difficult to accomplish in the case of large areas of the substrate and also in the case of very fine patterns, particularly with adhesion films or metal foil masks. Furthermore, the wetting behavior of the substrate surface is more or less strongly influenced by the mask or by the process steps for placing the mask and for removing the mask (e.g. the photolithographic mask), respectively.

It becomes apparent from these drawbacks that the surface energies of the regions to be patterned can only be controlled in practice with difficulty when such mask-based methods are employed.

J. Seo, E. Ertekin, M. S. Pio, L. P. Lee, “Self-Assembly Templates by Selective Plasma Surface Modification of Micropatterned Photoresist”, 2002 IEEE disclose a further way how hydrophilic and hydrophobic regions can be formed on a surface of an Si or SiO₂ wafer partly covered with a photoresist. First the wafer including the photoresist is hydrophilized by means of an O₂ plasma. Due to the subsequent action of a CF₄ or SF₆ plasma it is possible to hydrophobize the photoresist surface, whereas the Si or SiO₂ surfaces do not show such an effect and remain hyrophilized.

It is an object of the present invention to indicate a method for the selective coating of a surface on a substrate with liquid, which does not require a masking technique for accomplishing a selective wetting of the patterns and which can particularly manage without a photoresist layer.

The aforementioned object is achieved according to the invention with a method for the selective coating of a surface of a substrate with liquid, wherein the surface to be selectively coated with liquid comprises regions exhibiting different surface energies, and wherein prior to wetting a fluorine-containing plasma gas is directly acting on the regions exhibiting different surface energies. Here the substrate comprises at least one region with a plastic surface and at least one region with a metal surface or an inorganic surface, wherein the fluorine-containing plasma gas is directly acting on said regions, whereby the plastic surface is hydrophobized and the metallic or the inorganic surface is hydrophilized.

In the solution according to the invention, the fluorine-containing plasma is acting on the whole surface of the substrate over the whole area, i.e. it is directly acting on the surface, so that no masking technique is needed for effecting a selective use of the patterns. To be more specific, a photoresist layer is also not needed. This photoresist layer would mostly be objectionable as a layer in the assembly of an electronic component because it is not permanently stable.

The substrate may here be a metal-patterned plastic film having a surface that is treated with the fluorine-containing plasma gas. The application of the present method to plastic films permits the use of the method for self-controlled coating processes in the manufacture of electric circuits on particularly flexible substrates.

The substrate may also be a plastic substrate, with patterned metal surfaces being present on the substrate surface to be selectively coated with liquid. The substrate may also be made from any desired material, said substrate being coated on one or both sides with a plastic layer having a surface which is to be selectively coated with liquid and has formed thereon metal patterns on one or both sides. The substrate may here also be made of any desired material, the substrate being coated with metal which in turn is covered by a plastic layer that comprises defined opening patterns. The substrate may also be made of a metal foil which is covered at one or both sides with a plastic layer exhibiting defined opening patterns.

According to a further preferred embodiment a CF₄ plasma, SF₃ plasma, SF₆ plasma or mixtures of one of said plasmas with oxygen or nitrogen, particularly an F/C/O₂ plasma, preferably consisting of 60% by volume of CF₄ and 40% by volume of O₂ or of 80% by volume of CF₄ and 20% by volume of O₂ is acting on the surface to be coated.

The plasma may be acting on the surface as a low-pressure plasma, preferably at a chamber pressure of 0.1 to 100 mbar, or it may be acting on the surface as an atmospheric plasma at standard pressure.

The plasma action can further tale place in a continuous process, and the liquid may also be applied to the plasma-treated surface in a continuous process.

Water, solvents, varnishes, electrically insulating or conductive polymers, conductive inks or low-viscosity adhesives may be used as a liquid for selective wetting.

The plasma action can particularly be employed as a preparatory step for a self-controlling coating process in the manufacture of electric circuits on a particularly flexible substrate.

The liquid for the selective wetting may also contain solids and/or functional components, so that the plasma action can be used as a preparatory step for a self-controlling assembly of small objects or components.

Further embodiments are the subject of further dependent claims.

The present invention shall now be explained in more detail with reference to preferred embodiments in conjunction with the associated drawing.

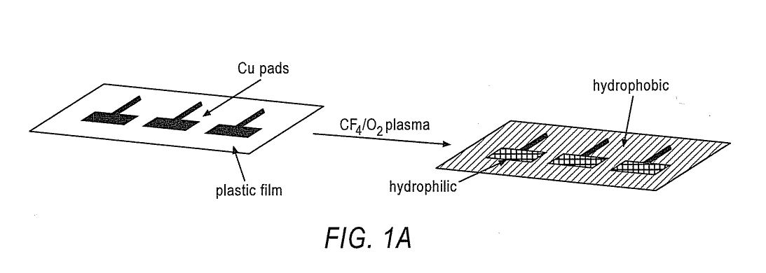

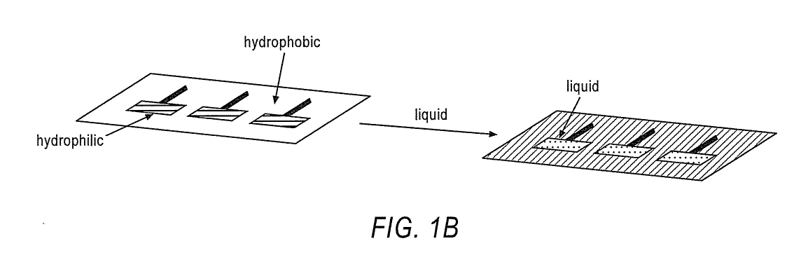

FIGS. 1A and 1B schematically show a preferred embodiment of the method for the selective coating of a surface of a substrate.

The wettability of surfaces by specific liquids is normally characterized by the contact angle of a liquid drop on the surface. Small contact angles in the present context mean that the liquid drop is spreading, i.e. wetting is excellent. By contrast, large contact angles mean that the liquid drop stops so that, when viewed in cross section, very large angles are formed between substrate surface and drop surface, which means poor wettability.

In experiments the following wettability values were found according to the Table shown hereinafter for water drops on surfaces made of gold, aluminum, copper, silicon, PET (polyethylene terephthalate) and polyimide after different plasma treatments.

| | Contact angle of a water | Contact angle of a water |
|---|---|---|
| | drop after CF₄/O₂ plasma | drop after O₂/N₂ plasma |
| | action on the corresponding | action on the corresponding |
| Surfaces | surface | surface |
| gold, copper, | 0-10° | 0-10° |
| aluminum | | |
| silicon | 40-60° | 0-10° |
| silicon dioxide | 40-50° | 0-10° |
| silicon nitride | 40-50° | 0-10° |
| PET | 100-110° | 0-10° |
| polyimide | 100-110° | 0-10° |

As becomes apparent from the values of this Table, the indicated surfaces made from plastics, metals, semiconductors and insulators become in general very hydrophilic after the action of an oxygen/nitrogen plasma gas.

By contrast, action of a CF₄/O₂ plasma leads to very different contact angles on the various materials. As follows from the Table, a maximal wettability selectivity is achieved after action of the CF₄/O₂ plasma between metals (gold, copper, aluminum) and the plastic surfaces of polyimide and PET.

The conclusion can be drawn from these experimental data that a full-area plasma action on a surface comprising at least one region of plastics and at least one region of metal yields a maximum difference in the wettability of water.

According to the present teaching this wettability effect is exploited for coating a surface with a liquid such that only the metal patterns are wetted with the liquid. This wettability effect can just as well be exploited for the selective coating of a surface with liquid, the surface comprising at least one region of plastic and at least one region of inorganic material.

FIGS. 1A and 1B show the basics of this method using the example of a polyimide film (PI film) with copper pads (Cu pads) arranged on the surface of the PI film.

Here FIG. 1A shows the treatment of the patterned metal surface including the polyimide film with the CF₄/O₂ plasma, resulting in the different hydrophilic and hydrophobic regions, and FIG. 1B shows the subsequent coating with liquid, whereby the liquid deposits in the hydrophilic regions (Cu pads) because these are wettable in a much better way.

Due to the treatment with a CF₄/O₂ plasma or alternatively with a CF₄ plasma (or with another fluorine-containing plasma), the PI film becomes hydrophobic and the Cu pads hydrophilic. This creates, on the surface of the PI film, regions of different surface energies, i.e. hydrophobic and hydrophilic regions, whereby a maximal difference is achieved in the wetting behavior, which is then exploited for coating processes.

With the help of the present method plastic surfaces can be modified directly and in a chemical way by direct action of a fluorine-containing plasma gas (CF₄/O₂ plasma or CF₄ plasma). By comparison, with inorganic surfaces and also with metals, a cleaning effect due to a plasma etch process is primarily observed upon action of a fluorine-containing plasma. As a consequence, the action of the fluorine-containing plasma on the plastic surface leads to a hydrophobization of the surface, whereas metallic surfaces and inorganic surfaces, respectively, are substantially only cleaned by the fluorine-containing gas, whereby the hydrophilicity of the metal surface or the inorganic surface, respectively, is maximized.

If patterned metallic regions (e.g. conductors) are now positioned on a plastic surface (e.g. a plastic film), the surface has disposed thereon regions with a plastic surface next to regions with a metallic surface. The action of a fluorine-containing plasma (e.g. CF₄ plasma) has the effect that the non-metallic regions (plastic regions) are hydrophobized and the metallic regions (the conductors) remain hydrophilized. Regions that wet very well (the metallic patterns) and very poorly (the plastic material) can thereby be created on metal-patterned plastic films, as are e.g. used in flexible electronics, without a complicated masking technique being needed for this. And this very effect can be used for coating these plastic films.

According to the present embodiment the fluorine-containing plasma (CF₄ plasma or CF₄/O₂ plasma) acts on the whole plastic film over the (whole) area and directly. The organic surfaces of the plastic film are hydrophobized; the inorganic or metallic surfaces are hydrophilized.

Thus according to the described and preferred embodiment a plastic substrate is provided as the substrate, with patterned metal surfaces being present on the surfaces of the substrate to be treated, with the plasma acting all over the whole surface and directly, so that a complicated masking technique can be omitted. The substrate may here be rigid or flexible. The metal patterns may e.g. be copper, aluminum or also precious metals.

However, according to an alternative embodiment the substrate may also be made from any desired material coated at one or both sides with a plastic layer, with metal patterns being formed on the surface of the plastic layer at one or both sides of the substrate.

According to a further alternative embodiment the substrate is made from any desired material that is coated with metal, which on its part is covered with a plastic layer, said plastic layer exhibiting defined opening patterns.

The substrate may also be a metal foil which is coated at one or both sides with plastics, said plastic layer in turn exhibiting defined opening patterns.

The metal patterns can be formed in a standard lithographic process, as is known from the manufacture of printed circuit boards. Alternatively, the metal patterns may be patterned in a printing technique onto the foil or the plastic substrate (ink-jet or screen printing).

The present method may also be devised as a low-pressure plasma method; this means that the plasma action can be effected at a chamber pressure of 0.1 to 100 mbar. Use as an atmospheric plasma is also possible, with the atmospheric plasma acting on the substrate surface at a standard pressure.

Fluorine-containing gases are suited as plasma gases, e.g. CF₄, SF₃, SF₆, or also mixtures thereof with oxygen or nitrogen. A mixture consisting of 60% by volume of CF₄ and 40% by volume of O₂, or 80% by volume of CF₄ and 20% by volume of O₂ has turned out to be particularly advantageous.

Water, solvents, varnishes, electrically insulating or conductive polymers and low-viscosity adhesives, etc. may be used as liquids for selective wetting. Moreover, liquids may be applied that contain solids or functional components; in this variant of the method the present method can be used as a partial step for the self-controlled assembly (“self assembly”) of small objects or components.

The foil substrate may be coated in a continuous process. In this case the substrate is brought into contact with a liquid after full-area plasma treatment. This may be performed by immersion, doctor blade coating, dispensing or printing.

Another possible application is the selective and self-controlled application of an adhesive layer to a surface. This may e.g. be employed for placing electrical or electronic components.

Another possible application is the bonding of substrates having patterned surfaces, e.g. wafer-to-wafer bonding processes (“waferbonding”) with a patterned adhesive layer. It is here particularly advantageous that also micropatterned adhesive lines or adhesive surfaces can be coated automatically and selectively with adhesive. Thus a complicated computer-controlled dispensing device is not needed.

Another possible application is the coating of large-volume objects, particularly with three-dimensionally shaped surfaces.

Another possible application is the selective application of liquids containing solids or functional components. In this variant, the present method can be used as a partial step for the self-controlled assembly (“self assembly”) of small objects or components.

It is advantageous in the present method that the plasma can act directly and preferably over the whole area on the whole surface of the substrate. Thus the use of a masking technique is not needed for performing a selective wetting of the patterns. A photoresist layer, in particular, is also not needed. This layer would mostly be objectionable as a layer in the assembly of an electronic component because it is not permanently stable.

Moreover, the present method is also applicable to plastic films. This permits the use of the novel method for self-controlled coating processes in the manufacture of electronic circuits on flexible substrates.

Furthermore, the direct plasma action can also be used for continuous processes (“roll to roll”).

1. A method for selectively coating a surface of a substrate with liquid, wherein the surface to be selectively coated with the liquid comprises regions exhibiting different surface energies, and wherein prior to wetting a fluorine-containing plasma gas is directly acting on the regions exhibiting different surface energies, wherein the substrate comprises at least one region with a plastic surface and at least one region with a metal surface or an inorganic surface, and wherein the fluorine-containing plasma gas is directly acting on said region, whereby the plastic surface is hydrophobized and the metallic or the inorganic surface is hydrophilized.

2. The method for selectively coating a surface with liquid according to claim 1, wherein the substrate is a metal-patterned plastic film having a surface treated with the fluorine-containing plasma gas.

3. The method for selectively coating a surface with liquid according to claim 1, wherein the substrate is a plastic substrate whose surface to be selectively coated with liquid has provided thereon patterned metal areas.

4. The method for selectively coating a surface with liquid according to claim 1, wherein the substrate is made of any desired material that is coated on one or both sides with a plastic layer whose surface to be selectively coated with liquid has formed thereon metal patterns at one or both sides.

5. The method for selectively coating a surface with liquid according to claim 1, wherein the substrate is made from any desired material coated with metal that on its part is covered by a plastic layer having defined opening patterns.

6. The method for selectively coating a surface with liquid according to claim 1, wherein the substrate is made of a metal foil coated at one or both sides with a plastic layer that has defined opening patterns.

7. The method for selectively coating a surface with liquid according to claim 1, wherein a CF₄ plasma, SF₃ plasma, SF₆ plasma or mixtures of one of said plasmas with oxygen or nitrogen, particularly an F/C/O₂-plasma, preferably of 60% by volume of CF₄ and 40% by volume of O₂ or 80% by volume of CF₄ and 20% by volume of O₂, is acting on the surface to be coated.

8. The method for selectively coating a surface with liquid according to claim 2, wherein the metal patterns are patterned in a lithographic process or by means of a printing technique onto the foil or the plastic substrate.

9. The method for selectively coating a surface with liquid according to claim 1, wherein the plasma is acting on the surface as a low-pressure plasma, preferably at a chamber pressure of 0.1 to 100 mbar, or wherein the plasma is acting on the surface as an atmospheric plasma at a standard pressure.

10. The method for selectively coating a surface with liquid according to claim 1, wherein the plasma action takes place in a continuous process.

11. The method for selectively coating a surface with liquid according to claim 1, wherein the liquid is applied to the plasma-treated surface in a continuous process.

12. The method for selectively coating a surface with liquid according to claim 1, wherein water, solvents, varnishes, electrically insulating or conductive polymers, conductive inks or low-viscosity adhesives are used as a liquid for selective wetting.

13. The method for selectively coating a surface with liquid according to claim 1, wherein the plasma action is used as a preparatory step for a self-controlling coating process in the manufacture of electric circuits on a particularly flexible substrate.

14. The method for selectively coating a surface with liquid according to claim 1, wherein a liquid containing solids and/or functional components is used as a liquid for selective wetting, so that the plasma action is used as a preparatory step for a self-controlling assembly of small objects or components.
